(19) United States
(12) Patent Application Publication
(10) Pub. No.: US 2011/0181135 A1
(43) Pub. Date: Jul. 28, 2011

(54) MICRO-STEPPING RELUCTANCE MOTOR

(75) Inventors: Charles Pollock, Oakham (GB); Helen Pollock, Oakham (GB)

(73) Assignee: TECHNELEC LTD, Oakham (GB)

(21) Appl. No.: 13/057,635

(22) PCT Filed: Aug. 6, 2009
(86) PCT No.: PCT/GB2009/001921

§ 371 Date: Apr. 5, 2011

(30) Foreign Application Priority Data
Aug. 7, 2008 (GB) 0814389.3

(51) Int. Cl. H02K 37/04

(52) U.S. Cl. 310/49.46

(57) ABSTRACT

The present invention relates to control of electrical motors and in particular, to the design and control of reluctance motors capable of micro-stepping position control. According to the invention there is provided a single stack variable reluctance machine with salient stator teeth and salient rotor teeth, the stator further comprising field magnet sections created by either permanent magnets or field windings or a combination of permanent magnets and field windings, and further comprising armature windings connected to form at least two armature phase windings, the armature phase windings connected to a power source or power electronic inverter for the supply of positive and negative current to at least two armature phase windings such that the rotor rotates in small incremental steps in response to small changes in the current in one or more of the phase windings.

The present invention relates to control of electrical motors and in particular, to the design and control of reluctance motors capable of micro-stepping position control.

Hybrid stepping motors are well known for their ability to operate in an open loop positioning mode, the rotor following a sequence of stator excitation pulses. The hybrid stepping motor is usually operated without any shaft position feedback in simple open loop position control systems. One common hybrid stepping motor has 50 rotor teeth and two phase windings. If positive current in one phase winding is switched off and is followed by positive current in the second phase winding, the rotor will move by 1.8° (one full step). A further full step in the same direction would occur if the second phase winding were de-energised and negative current applied to the first phase winding. There will be 200 discrete, full steps or holding torque positions of the rotor per revolution. The number of holding positions can be doubled by energising the second phase winding before the first is de-energised. This “two phase on—one phase on—two phase on” pattern is known as half stepping, producing 400 steps per revolution. By increasing the current in the second phase winding in small incremental steps while decreasing the current in the first phase winding in similar decrements it is possible to achieve very high open loop position control without the need for any position sensors. This mode is known as micro-stepping and stepper motors offering resolution of 50,000 steps per revolution have been developed. Hybrid stepping motors are therefore excellent for achieving smooth position control.

The high number of rotor teeth means that for each revolution of the motor there are 50 electrical cycles in the phase windings. For a stepping motor to spin at 3000 r/min would need electrical excitation in each winding of 2500 Hz. This leads to very high losses in the magnetic circuits and creates significant challenges for electronic controllers to generate the high frequency currents. The hybrid stepping motor is therefore an excellent machine for low speed accurate positioning but is usually limited to speeds less than 2000 r/min.

Switched reluctance motors, originally known as single stack variable reluctance stepping motors, have salient pole stator and rotor designs, and can be used as a large angle stepping motor with the capability to operate at higher rotational speeds without excessive losses in the magnetic circuits. The salient pole structure does however create discrete positions where the rotor and stator teeth are in complete alignment. As the current excitation is altered between one phase winding and the next phase winding the rotor of a switched reluctance or variable reluctance stepping motor will tend to move suddenly from one aligned position to the next. It is not possible to use an open loop control method to hold the rotor at intermediate positions between aligned positions of adjacent stator phase windings. It is not therefore possible to use micro-stepping techniques with a single stack variable reluctance stepping motor according to the prior art.

Similar difficulties occur in brushless permanent magnet synchronous motors. The brushless permanent magnet synchronous motor has magnetic poles on the rotor and a stator carrying the phase windings. The major difficulty with employing a brushless permanent magnet synchronous motor as a micro-stepping motor is caused by the cogging torque. This is a reluctance torque created by the interaction of the permanent magnet rotor and the teeth on the laminated stator structure. Even with zero stator currents there is a torque which will tend to hold the rotor in preferred positions. This cogging torque interacts with the electromagnetic torque produced by the stator phase currents, with the result that operation of such a motor in microstepping modes produces uneven positioning of the rotor. The current has to be increased to overcome the cogging torque and then the rotor jerks to the next cogging position.

Multi-stack variable reluctance motors do not have permanent magnets and therefore do not have any cogging torque. They also overcome the limitations of the single stack variable reluctance stepping motor. The motor is divided along its axial length into magnetically isolated sections “stacks”, and each of these sections can be excited by a separate winding. The teeth on the different stator stacks are misaligned relative to the other stators. The teeth on the rotor are usually all arranged with the same alignment. The holding position of the rotor therefore moves as the excitation is applied to each of the stator stacks in turn. Since the stacks of the motor are magnetically isolated the torque produced by each can be applied to the shaft in a cumulative manner and the rotor can be held in positions part-way between aligned positions of each stack. This motor does allow large angle steps, thus providing a motor suitable for high speed and positioning applications. However the complex construction of placing three magnetically isolated stators within the same machine makes the motor larger than competing machines for a given torque output.

It is the object of the present invention to provide a single stack variable reluctance machine which is simple to construct with field magnet sections on the stator and two or more armature phase windings also on the stator with a suitable power electronic inverter to give micro-stepping capability such that small changes in the magnitudes of one or more armature phase winding currents cause small changes in the angular position of the rotor to create a micro-stepping reluctance machine.

According to the invention there is provided microstepping reluctance motor comprising a single stack variable reluctance machine with salient stator teeth and salient rotor teeth, the stator further comprising field magnet sections created by either permanent magnets or field windings or a combination of permanent magnets and field windings, the field magnet sections located in the spaces between every alternate stator tooth and further comprising armature windings each spanning two stator teeth connected to form at least two armature phase windings, the armature phase windings connected to a power electronic inverter for the supply of positive and negative current to the armature phase windings, the power electronic inverter also capable of modulating the magnitude of the current in each armature phase winding, and capable of supplying variable current simultaneously to at least two armature phase windings such that the rotor rotates in small incremental steps in response to small changes in the current in one or more of the energised armature phase windings during any part of the machine operation.

The invention will now be described by reference to the following figures in which:

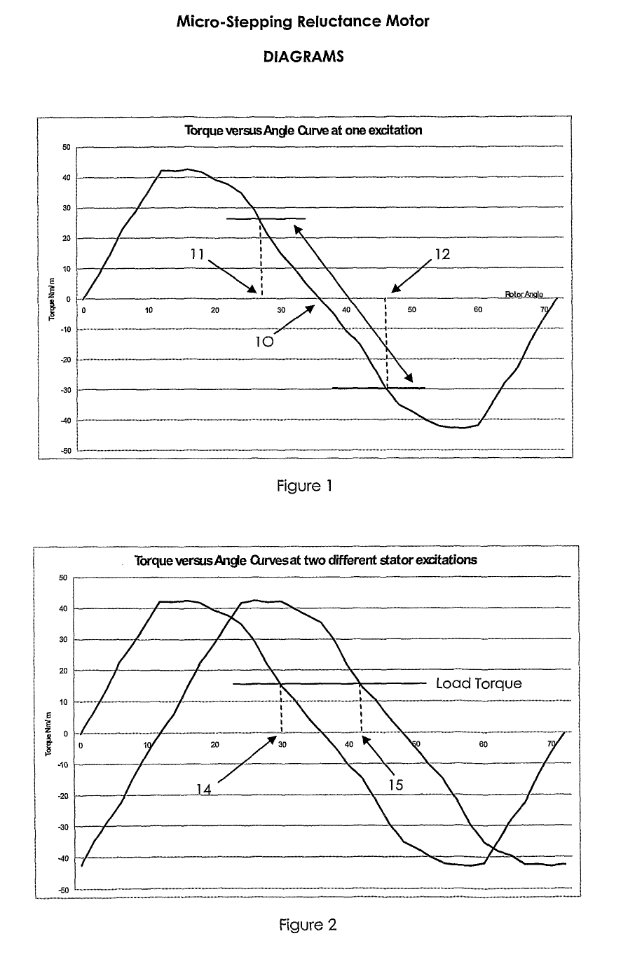

FIG. 1 shows a torque versus angle curve for an electrical machine according to the invention with one particular stator excitation;

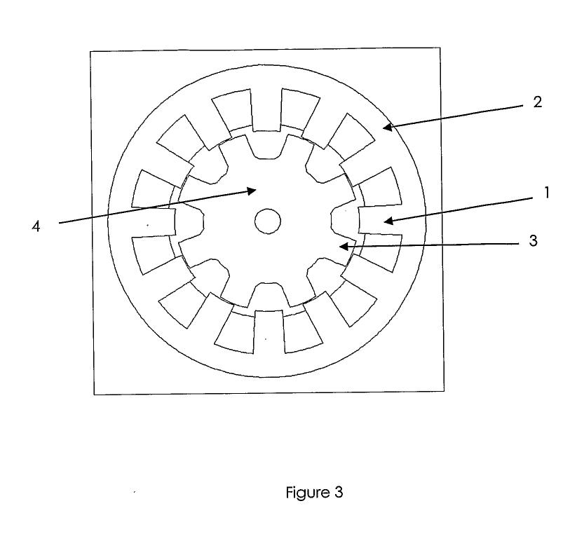

FIG. 2 shows two torque versus angle curves for an electrical machine according to the invention with two different stator excitations;

FIG. 3 shows a prior art switched reluctance or single stack variable reluctance motor;

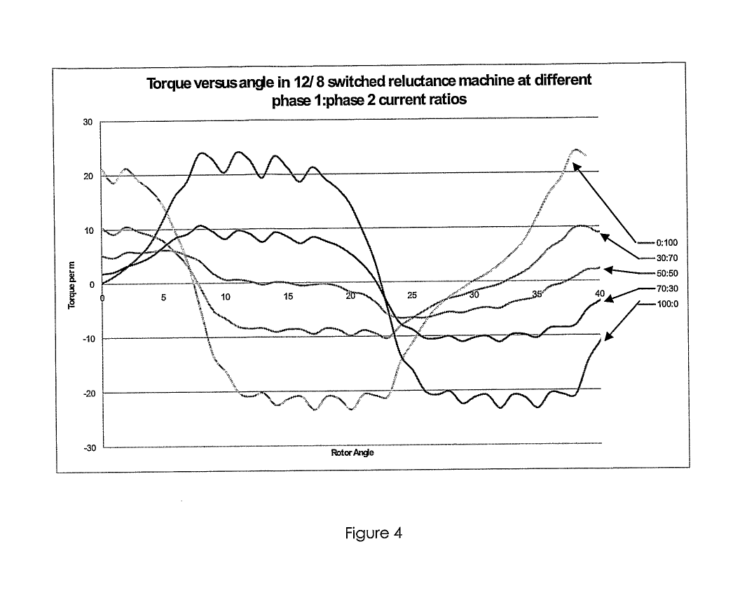

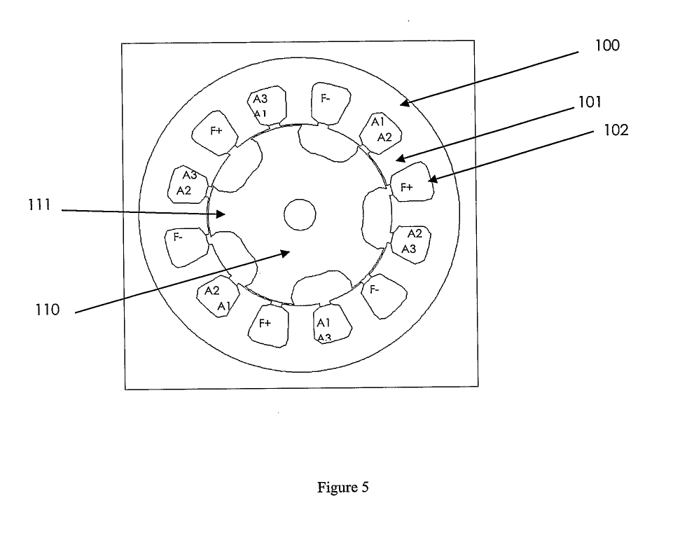

FIG. 4 shows a series of torque verses angle plots for a switched reluctance motor;

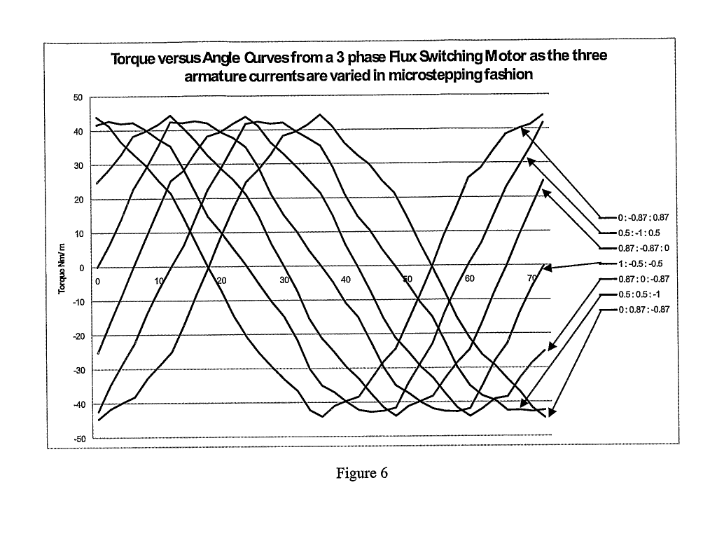

FIG. 5 shows a micro-stepping reluctance motor according to this invention with three armature phase windings;

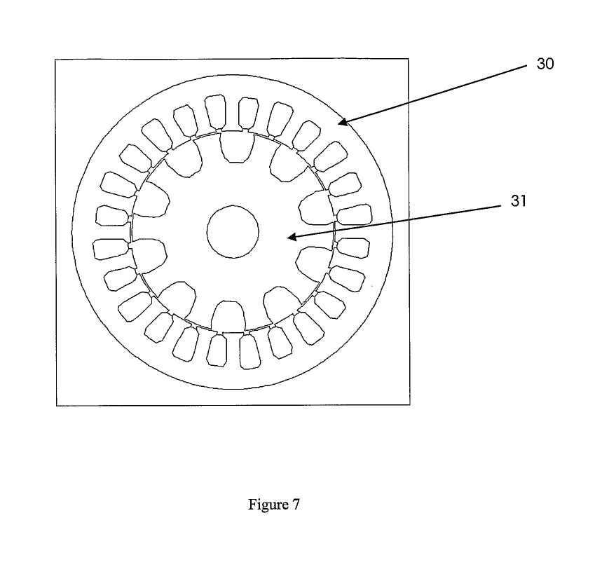

FIG. 6 shows a series of torque verses angle plots for a three phase micro-stepping reluctance motor according to the invention;

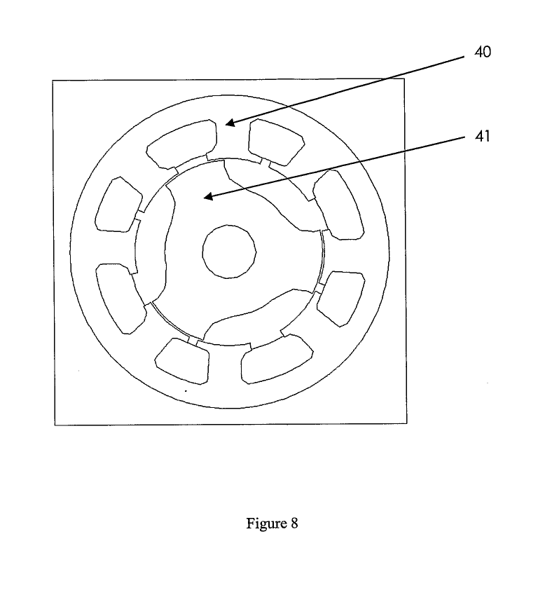

FIG. 7 shows a further micro-stepping reluctance motor according to this invention with three armature phase windings;

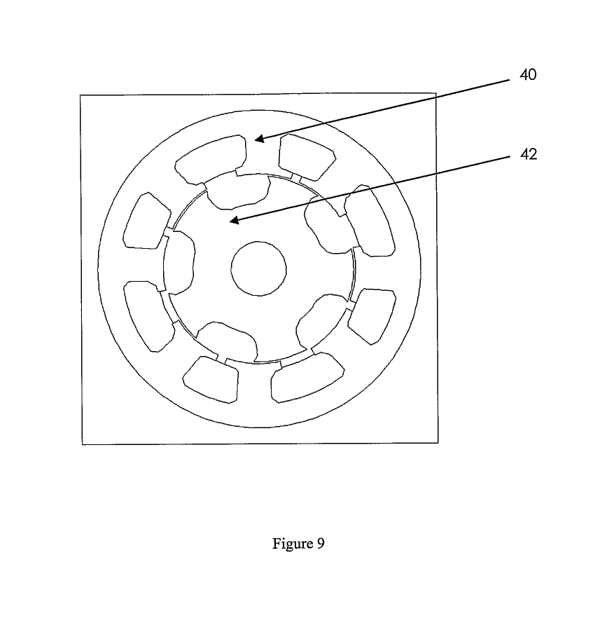

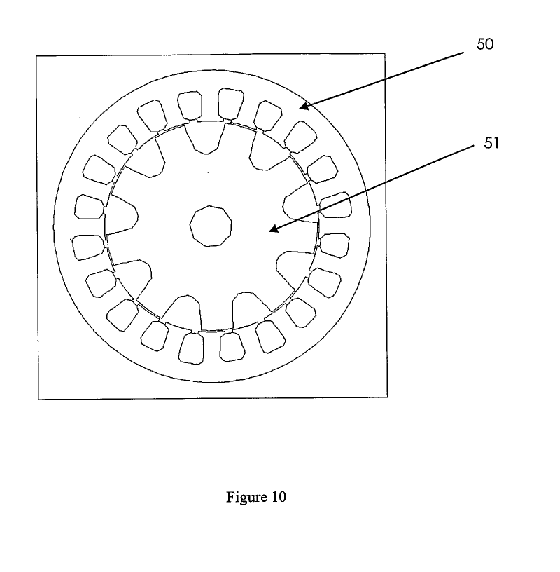

FIGS. 8 and 9 shows two phase micro-stepping reluctance motors according to the invention;

FIG. 10 shows a five phase micro-stepping reluctance motor according to the invention;

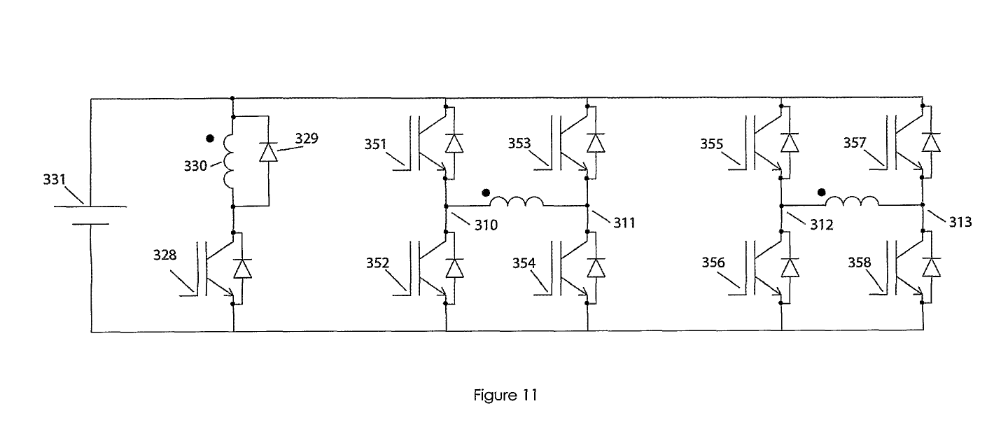

FIG. 11 shows a power electronic inverter for a two phase micro-stepping reluctance motor according to the invention;

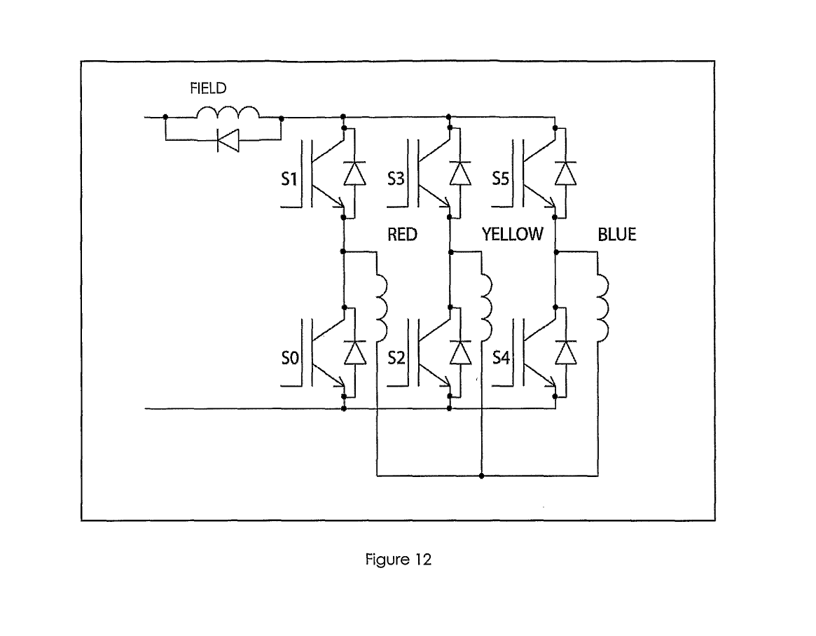

FIG. 12 shows a power electronic inverter for a three phase micro-stepping reluctance motor according to the invention.

FIG. 1 shows a torque versus angle curve for an micro-stepping reluctance electrical machine according to the invention. This curve shows the torque produced by the stator on the rotor at a fixed stator excitation. If there is no load on the shaft the rotor would come to rest at position 10. At this point the torque versus angle curve crosses the X axis with a negative gradient. If a load is applied which acts on the shaft to reduce the rotor angle, a positive torque is produced by the static magnetic of the stator which opposes the applied load torque and the rotor will take up a new holding position at position 11. If a load is applied which acts on the shaft to increase the rotor angle, a negative torque is produced by the static magnetic of the stator which opposes the applied load torque and the rotor will take up a new holding position at position 12.

FIG. 2 shows two torque versus angle curves for an micro-stepping reluctance electrical machine according to the invention with two different stator excitations. These graphs illustrate the principle of micro-stepping and show that at a given load the holding position of the rotor can be moved from 14 to 15 by changing the excitation of the armature phase windings in the stator.

FIG. 3 shows a three phase switched reluctance motor (single stack variable reluctance stepping motor) from the prior art. The motor illustrated has twelve salient teeth 1 on the stator 2 and eight salient teeth 3 on the rotor 4. The stator teeth are magnetised by coils wound around each tooth. In this example of a prior art three phase switched reluctance motor, coils wound around four stator teeth, separated by 90°, would be connected together to create each phase winding. Energisation of the four coils associated with each phase winding would create a four pole magnetic field with two north poles and two south poles. Four of the eight rotor teeth, nearest to the energised stator teeth will be attracted to the four energised stator teeth causing the rotor to rotate until four of the rotor teeth are completely aligned with the energised stator teeth.

Further rotation is achieved by energising the four stator teeth of one of the other two phases causing the second set of four rotor teeth to be attracted to the energised stator teeth. The switched reluctance motor therefore can act as a large angle stepping motor and as such is known in the prior art as a single stack variable reluctance stepping motor. The magnitude of each full step is dependent on the number of teeth on the stator and rotor and on the number of phase windings. Some common examples from the prior art are given in Table 1.

TABLE 1
Common configurations of single stack variable reluctance motors
(switched reluctance motors) with the step angle moved by the
rotor with one change in phase winding excitation.

| Phase windings | Stator teeth | Rotor teeth | Rotor Step Angle |
|---|---|---|---|
| 3 | 6 | 4 | 30° |
| 3 | 6 | 8 | 15° |
| 3 | 12 | 8 | 15° |
| 4 | 8 | 6 | 15° |

Recently the switched reluctance machine has been successfully employed in many applications as a variable speed motor since the rotor is of very simple construction. At low speeds however the movement of the rotor is very uneven with the torque to angle characteristic being very non-linear with current and position. This makes the switched reluctance motor (single stack variable reluctance motor) very unsuitable for positioning applications, particularly where angular movement of less than one full step is required.

To illustrate the problems of controlling the rotor of a switched reluctance motor from one holding torque position to the next holding torque position reference can be made to FIG. 4 which shows the torque versus angle curves for the switched reluctance motor shown in FIG. 1 as the current is changed gradually from 100% in phase winding 2 to 100% in phase winding 1.

The stable or holding torque position with no load applied to the rotor for 100% Phase 2 (Line 0:100 in FIG. 4) is 7.5°. From this position if a load torque is applied to the rotor which tends to increase the rotor angle, the torque developed by the motor is negative which is in a direction which will tend to decrease the angle and pull the rotor back towards the holding torque position. If a load torque is applied to the rotor which tends to decrease the rotor angle, the torque developed by the motor is positive which is in a direction which will tend to increase the angle and pull the rotor back towards the holding torque position.

When the torque versus angle curve at a particular excitation crosses the X-axis with a negative gradient, this corresponds to a stable or holding torque position for that excitation. The gradient of the torque versus angle as it passes through the holding torque position determines the stiffness of the holding position and the peak holding torque or pull out torque is shown as the peak positive or negative torque as the rotor is moved either side of the holding position.

When the current in phase 2 is decreased to 70% and current in phase 1 has increased to 30% the stable position has only moved by about 0.5° to 8°. Therefore a large change in the relative proportions of the currents in phase winding 1 and phase winding 2 does not result in a progressive change in the stable (parking or holding) position. Furthermore the peak holding torque is now approximately 50% of the original value with one phase excited.

When the currents in phase 1 and phase 2 are both 50% the torque vs angle plot is very flat with no distinct holding position.

When the current in Phase 1 becomes greater than phase 2 the rotor will move to be near the stable position where the rotor teeth are aligned with the stator teeth of Phase winding 1. This position is at 22.5° which is one full step of 15° away from the stable position of Phase winding 2.

This data confirms that a conventional switched reluctance machine cannot be used in half-stepping or micro-stepping modes since the holding position cannot be moved progressively, in small incremental steps, from a first holding position to a second holding position. The present invention overcomes this limitation of prior art switched reluctance motors when used in positioning applications.

A micro-stepping reluctance motor comprising a single stack variable reluctance electrical machine according to this invention which overcomes the disadvantage of the switched reluctance machine for open loop positioning applications will now be described. One example of the single stack variable reluctance electrical machine according to the invention is shown in FIG. 5. Like the prior art variable reluctance stepping motor it also has a simple rotor with no magnets or windings which can be manufactured at very low cost. Unlike the prior art switched reluctance motors, the single stack variable reluctance motor according to the invention has a field winding on the stator which controls the flux in the machine and the machine has additional armature phase windings connected, for example to create two, three or five armature phase windings.

The example micro-stepping reluctance motor shown in FIG. 5 is a three phase, single stack, variable reluctance motor and has a stator 100 carrying twelve salient teeth 101. Interspersed between the stator teeth, the stator has twelve slots 102. In the example shown in FIG. 3 the rotor, 110, has five salient teeth, 111, with no windings or permanent magnets. The field winding, F, and three armature windings A1, A2, A3 are all on the stator. Each winding is pitched over two stator teeth. The field winding F creates six field magnet sections. Alternate field excitation sections of the stator will be configured with opposing magnetic polarity. As an alternative a single stack variable reluctance motor according to the invention can have field winding sections comprising both field windings and permanent magnets as disclosed in GB2454171A. The field magnet sections could also be totally provided by permanent magnets with no field windings.

The unusual stator to rotor tooth geometry of the three phase single stack variable reluctance motor means that it can be used in a micro-stepping mode with a progressive change in holding position as the current in the armature phases windings are altered by small increments using a suitable power electronic controller. As a result the three phase single stack variable reluctance motor according to the invention can be used very successfully as an open loop micro-stepping motor. The plots shown in FIG. 6 show the torque versus angle of the three phase single stack variable reluctance motor of FIG. 5 as the armature phase winding currents in the three armature phase windings are altered with an excitation pattern which corresponds to a sinusoidal variation in each phase winding with position. The excitation in each armature phase winding is chosen to be 120 electrical degrees apart from its neighbouring two phase windings.

The results of the torque versus angle at each set of stator currents is shown in FIG. 6. Each plot in FIG. 6 is obtained by advancing the stator current excitation and the resulting stator flux vector by an equivalent of 6° (mechanical), 30° (electrical). It can be seen that the static torque curve for each position moves by the same 6° (mechanical) without any substantial change in the shape of the curve. The pull out torque is maintained at a constant value as the excitation is changed. The holding torque positions with no load are where the curves cross the X axis with negative gradient.

Other three phase single stack micro-stepping reluctance motors according to the invention with smaller full step angles and more electrical cycles per revolution are summarised in Table 2.

TABLE 2

| | | | Electrical | | |
|---|---|---|---|---|---|
| | | | cycles | | Full step |
| Phase Windings | Stator teeth | Rotor Teeth | per rev | | size |
| 3 | 12 | 5 | 5 | (72°) | 12° |
| 3 | 12 | 11 | 7 | (51.43) | 8.57° |
| 3 | 24 | 10 | 10 | (36°) | 6° |
| 3 | 24 | 22 | 14 | (25.71°) | 4.29° |

FIG. 7 shows a micro-stepping reluctance motor with a three phase single stack variable reluctance motor with stator 30 carrying twenty-four stator teeth and rotor 31, with ten rotor teeth. This motor has ten electrical cycles per revolution i.e. the same number as it has rotor teeth. Each electrical cycle lasts for 36° (mechanical degrees). Each electrical cycle can be divided into 6 full step positions if the excitation in each phase winding progresses from positive to negative dc current values. Operation of the machine in FIG. 5 according to the invention in a micro-stepping mode can offer very fine resolution position control without the complexity of prior art micro-stepping machines.

A micro-stepping reluctance motor with a single stack variable reluctance motor with a stator 40 with eight stator slots can be configured as a two phase motor as shown in FIGS. 8 and 9. The rotor can have either 3 teeth (41 in FIG. 8) or 5 teeth (42 in FIG. 9).

The micro-stepping reluctance motor with a two phase motor with 3 teeth offers 12 full steps per rev and with 5 rotor teeth offers 20 full steps per rev. Both motors can be used in a micro-stepping mode because of the smooth change in flux linkage in each phase winding with position.

Examples of five phase micro-stepping reluctancemotors according to the invention can have, by means of example, the numbers of stator and rotor teeth shown in Table 3. An example of a 5 phase single stack variable reluctance motor according to the invention is shown in FIG. 10. This example the stator 50 has twenty stator teeth and the rotor 51 has nine rotor teeth. It has nine electrical cycles per revolution and each electrical cycle can be sub-divided into micro-steps according to this invention by simultaneous control of at least two of the five armature windings.

TABLE 3

| | | | Electrical | |
|---|---|---|---|---|
| | | | cycles | Full step |
| Phases | Stator teeth | Rotor Teeth | per rev | size |
| 5 | 20 | 9 | 9 (40°) | 4° |
| 5 | 20 | 11 | 11 (32.73) | 3.273° |

Micro-stepping reluctance motors can be constructed according to this invention with a field excitation means and two or more armature windings. The stator of the machines will always have an even number of teeth, Nₛ. In the spaces between every alternate stator tooth there will be a field excitation means such that the field excitation means occupies Nₛ/2 spaces between the stator teeth. The field excitation means will comprise either an electrical winding carrying dc current or a permanent magnet magnetised to create an mmf acting tangentially or may contain a combination of an electrical winding and a permanent magnet acting together to create the tangential mmf. Alternate field excitation sections of the stator will be configured with opposing magnetic polarity.

In a machine according to the invention there will also be armature coils occupying the spaces or slots between alternate armature teeth and in the slots not already occupied by the field excitation means and spanning a pitch of two stator teeth. The armature coils of each phase will be connected usually in series to create q armature phase windings where q is an integer number greater than one.

The number of stator teeth, Nₛ, is given by the following equation:

Nₛ=4q*n

Where n is a positive integer, 1, 2, 3, 4, . . . representing the repetitions within the machine.

The number of rotor teeth, Nᵣ, in a machine according to the invention is given by:

Nᵣ=(2q±1)*n

Constructing a micro-stepping reluctance motor from a single stack variable reluctance machine with Nₛ stator teeth and Nᵣ rotor teeth as described by the above equations, the stator further comprising Nₛ/2 field magnet sections, and armature windings connected to form at least two armature phase windings, the armature phase windings connected to a power electronic inverter for the supply of positive and negative current to the armature phase windings, the power electronic inverter also capable of modulating the magnitude of the current in each armature phase winding, and capable of supplying current simultaneously to at least two armature phase windings such that the rotor can move in small incremental steps in response to small changes in the current in one or more of the energised phase windings.

A power electronic inverter suitable for use with a two phase micro-stepping reluctance motor according to the invention is shown in FIG. 11. A dc power source 331 which may be a battery or may be created by rectification of an ac supply is connected to provide power to a field winding 330 and armature phase windings. The first armature winding has terminals 310 and 311 and is connected to a first inverter circuit with electronic switches 351, 352, 353 and 354. The second armature winding with terminals 312 and 313 is connected to a second inverter circuit comprising electronic switches 355, 356, 357 and 358. A further IGBT 328 controls the current through the shunt field winding 330. A diode 329 carries the field current when the IGBT 328 is turned off. Thus FIG. 11 allows the current in the first and second armature windings to be independently controlled thus allowing the rotor of the motor to be accurately positioned by the optimal choice of the currents flowing in the armature phase windings. This circuit shows the field winding in a shunt or parallel connection relative to the armature winding. Variants of the circuit in FIG. 11 would place the field winding in series with the incoming supply current. A diode or capacitor may be added to allow the field current to continue to flow while the armature windings are switched by the inverter.

FIG. 12 illustrates an inverter circuit which could be used with a micro-stepping reluctance motor according to the invention with three armature phase windings. The three armature phase windings are denoted by RED, YELLOW and BLUE. In this circuit the armature windings are connected in star configuration. As a result the motor cannot be operated in a “one phase on” mode. However in order to implement the invention, at least two armature phase windings must carry current at any one time and the inverter in FIG. 12 is suitable for the simultaneous control of two or three phase currents at any one time. At all times the current flowing in the three armature windings will have to satisfy the equation:

i_{RED}+i_{YELLOW}+i_{BLUE}=0

In order to implement precise position control of a three phase micro-stepping reluctance motor according to the invention, all three armature windings would carry current simultaneously. If i_{RED}>0 and i_{YELLOW}<0, then i_{BLUE} can be used to control the relative size of i_{RED} and i_{YELLOW} and move the rotor in small incremental steps. It will be common to force the three armature phase currents to have a value according to three sinusoidal equations, each with a phase displacement of 120° (2π/3 radians or in general 2π/q) such that

$${i}_{RED} = {I}_{max} sin [ {N}_{r} θ ]$$

$${i}_{YELLOW} = {I}_{max} sin [ {N}_{r} θ + \frac{2 π}{3} ]$$

$${i}_{BLUE} = {I}_{max} sin [ {N}_{r} θ + \frac{4 π}{3} ]$$

where θ is the mechanical angular position of the armature excitation vector at any point in time and Iₘₐₓ is the current required to deliver the torque on the shaft to avoid pull out.

If it is required to move the rotor position by 1° then the position of the effective stator current vector should be moved by 1°. As an example in a three phase motor with five rotor poles the stator excitation is initially located at 40° (mechanical). To achieve this the electrical excitation angle will be 200° (i.e. Nᵣθ). To move the rotor by 1° to 41° the electrical excitation needs to change by 5° to 205°. The values of the three phase currents before and after the move are shown in Table 4.

TABLE 4

| | Value to Position | Value to Position |
|---|---|---|
| | Stator Current | Stator Current |
| | Vector at 40° | Vector at 41° |
| | (mechanical) | (mechanical) |
| i_{RED} | −0.342* Iₘₐₓ | −0.423* Iₘₐₓ |
| i_{YELLOW} | 0.985* Iₘₐₓ | 0.996* Iₘₐₓ |
| i_{BLUE} | −0.643* Iₘₐₓ | −0.573* Iₘₐₓ |
| i_{RED} + i_{YELLOW} + i_{BLUE} | 0 | 0 |

By controlling the three armature currents in the micro-stepping reluctance motor in this way the position of the rotor can be changed in small angular increments without requiring a high resolution position sensor to feedback the position of the rotor. Micro-stepping reluctance motors designed according to this invention can be simple and robust positioning devices without the requirement for position feedback. As the rotor does not carry a permanent magnet they do not suffer from any cogging torque problems which tend to cause unpredictable rotor movements in low speed positioning applications. The micro-stepping reluctance motors according to this invention are simpler to construct than the multi-stack variable reluctance motor or the hybrid stepping motor and yet can deliver open loop positioning without the use of a position sensor. This cannot be achieved with prior art designs of switched reluctance motors.

In a micro-stepping reluctance machine according to the invention with q phases, the rotor can be moved in small incremental steps by controlling the current in each armature phase winding to approximately follow a sinusoidal function of a given amplitude, while ensuring that the sinusoidal function for each consecutive armature phase winding has a phase difference relative to the previous armature phase winding of 2π/q electrical radians. At any point the excitation of the armature phase windings can be frozen at the magnitudes corresponding to the instantaneous values of the sinusoidal functions for each phase. At this point the torque angle curves for the motor will be a unique curve such as one of the curves shown in FIG. 6 and the rotor will stop its incremental rotation at a known rotor position. The invention can also be implemented with other current functions but the sinusoidal functions provide the simplest method of applying currents to different windings while the vector sum of the currents remains a constant magnitude but with variable angular position. It is also possible to add harmonic currents to the current function to improve torque magnitude for a given peak current. The sequence of the armature phase windings and the phase displacement between them can be confirmed by exciting the field magnet sections and spinning the rotor with no electrical excitation in the armature windings. Approximately sinusoidal emfs will be induced in the armature windings and the sequence and phase displacement between armature phase windings can be measured with an oscilloscope.

It will be appreciated that the currents in the armature phase windings do not need to be varied exactly according to the sinusoidal profiles in Table 4 and many other combinations of individual phase currents can be used to create small incremental changes in the position of the rotor.

The positioning scheme described can be used as a small part of an overall motor control strategy. For example the micro-stepping scheme according to the invention may be used to move a motor slowly and then when the speed increases an alternative control strategy using speed feedback may be used. This is a very common method of starting a motor before using a sensorless scheme which relies on some movement of the rotor to produce an armature emf which can be detected and used for control purposes. The invention therefore can be used as the main control of a micro-stepping reluctance motor as an open loop positioning device or the invention can be used for one operating region of a complete control system.

A further aspect of a micro-stepping reluctance motor according to this invention is that the position of the rotor can be tracked continuously irrespective of the method of control. If the control of a motor is transferred to a speed feedback scheme or sensorless control scheme after an initial excitation in micro-stepping mode a controller is still able to count the number of electrical cycles applied to the armature phase windings, thus maintaining an incremental position count, then as a motor slows down control could be returned to the micro-stepping control scheme according to this invention to bring the rotor to rest at a precise position.

1. An electrical machine comprising a single stack variable reluctance machine with salient stator teeth and salient rotor teeth, the stator further comprising field magnet sections created by either permanent magnets or field windings or a combination of permanent magnets and field windings, the field magnet sections located in the spaces between every alternate stator tooth and further comprising armature windings each spanning two stator teeth connected to form at least two armature phase windings, the armature phase windings connected to a power source for the supply of positive and negative current to the armature phase windings, the power source being also capable of supplying current simultaneously to at least two armature phase windings and modulating the magnitude of the current in at least one armature phase winding to create incremental rotational movement of the rotor during any part of the machine operation.

2. An electrical machine according to claim 1 with at least two armature phase windings wherein the number of stator teeth is a first positive integer multiple of four times the number of armature phase windings.

3. An electrical machine according to claim 2 wherein the number of rotor teeth is a second positive integer multiple of one more than twice the number of armature phase windings.

4. An electrical machine according to claim 2 wherein the number of rotor teeth is a second positive integer multiple of one less than twice the number of armature phase windings.

5. An electrical machine according to claim 3 wherein the first and second integer multiples are the same number.

6. An electrical machine according to claim 1 wherein the power source is an electronic inverter with at least one connection to each armature phase winding capable of supplying current simultaneously to at least two armature phase windings such that the rotor can rotate in small incremental steps in response to small changes in the current in one or more of the armature phase windings.

7. An electrical machine according to claim 6 wherein the electronic inverter further comprises connections to at least one field winding in the machine such that the amount of field current in the machine can be varied independently from the current in the armature phase windings.

8. An electrical machine according to claim 6 wherein the electronic inverter further comprises connections to at least one field winding in the machine such that the amount of field current in the machine can be varied in proportion to the current in the armature phase windings.

9. An electrical machine according to claim 1 wherein the currents in each armature phase winding are each controlled to a value such that the vector sum of the stator currents has a chosen magnitude and controllable angular position.

10. An electrical machine according to claim 1 wherein the stator has eight teeth and the rotor has three teeth and there are two armature phase windings.

11. An electrical machine according to claim 1 wherein the stator has eight teeth and the rotor has five teeth and there are two armature phase windings.

12. An electrical machine according to claim 1 wherein the stator has twelve teeth and the rotor has five teeth and there are three armature phase windings.

13. An electrical machine according to claim 1 wherein the stator has twelve teeth and the rotor has seven teeth and there are three armature phase windings.

14. An electrical machine according to claim 1 wherein the stator has twenty teeth and the rotor has nine teeth and there are five armature phase windings.

15. An electrical machine according to claim 1 wherein the stator has twenty teeth and the rotor has eleven teeth and there are five armature phase windings.

16. An electrical machine according to claim 1 where incremental changes in at least one of the currents flowing in the armature windings is used to rotate the rotor by incremental steps to establish rotation and once rotating the control of the machine is transferred to another type of controller.

17. An electrical machine according to claim 1 where there are q armature phase windings, wherein the currents in each armature phase winding are made to approximately follow a sinusoidal function, the phase displacement between the sinusoidal function for each consecutive armature phase current being equal to 2π/q electrical radians.

18. An electrical machine according to claim 17 wherein the current applied to each of q armature phase windings can be held constant at a value equivalent to the instantaneous values of the q sinusoidal functions during any part of the machine operation.
